(19) United States
(12) Patent Application Publication
(10) Pub. No.: US 2015/0081799 A1
(43) Pub. Date: Mar. 19, 2015

(54) SYSTEM FOR MANAGING ADMINISTRATIVE ELECTRONIC NOTIFICATIONS

(71) Applicants: Rodrigo Fernandez-Gil Goñi, Torrelodones (ES); Manuel Flores Ruiz, Madrid (ES)

(72) Inventors: Rodrigo Fernandez-Gil Goñi, Torrelodones (ES); Manuel Flores Ruiz, Madrid (ES)

(21) Appl. No.: 13/261,785

(22) PCT Filed: Mar. 30, 2012
(86) PCT No.: PCT/ES2012/000082

§ 371 Date: Jul. 23, 2014

(30) Foreign Application Priority Data
Jun. 1, 2011 (ES) P201100619

(51) Int. Cl. H04L 12/58

(52) U.S. Cl. CPC H04L 51/22; H04L 51/24; H04L 51/08
USPC 709/206

(57) ABSTRACT

The invention relates to a system for managing administrative electronic notifications of a service voluntarily or obligatorily provided to the end users and the authorized intermediaries thereof through web pages created for that purpose, consisting of a served connected via Internet to said web pages and to user terminals, provided with a data base administrator and a web application that make it possible to periodically recover, according to various search criteria, new notifications in the mailbox associated with each user by means of the corresponding digital certificate, processing and generating a report of said notifications and sending it electronically to the user terminal, along with the corresponding documents. The system solves the problem experienced by authorized users, such as handling centers, of having to make daily checks of the electronic mailboxes of the people they represent, and also useful to end users as an advisory service.

Present invention relates to a management system for electronic notifications issued by Spanish Administration or by any other foreign Administration or Organization and addressed to end users, either companies or individuals, and to their authorized intermediaries, both for compulsory and voluntary notifications, although it is specially aimed at managing compulsory electronic notifications, that in Spain are issued by Treasury (NEO system), and for which addressees claimed system is directly and specially applicable.

System has been developed with the purpose of solving the problem that for authorized intermediaries, such as agencies, consultancies, external accountants or handling centers means having to check almost daily electronic mailboxes of each of their clients, due to the official nature of those notifications and their imposed acknowledgment of receipt periods, that are only of ten days. However, system is also useful to end users as an advisory service.

For this purpose, using Spain as pilot scheme but foreseeing to extend the system for any administration having a Website similar to Spanish 060.es, what has been done is preparing a server, connected via internet to Web page 060.es and to terminals of system's enrolled users, equipped with an enrolled users database manager and a web application that allow system periodically retrieve, according to different parameters, new notifications contained on mailboxes associated to each user's Authorized Email Address (DEH in Spanish) by means of user's digital certificate, process these notifications, generate a daily report of new notifications and send it along with attached notifications to enrolled user's terminals or, additionally, by post.

Technical field of the invention is therefore related to computing, particularly to data processing systems specially adapted for administrative purposes.

### STATE OF THE ART

In recent years, a tendency to change official notifications from its traditional printed format to electronic formats via internet has been imposed by Governments. This responds to a clear costs saving policy, both in material and shipping costs, as well as to greater agility in delivery and response, and even to environmental factors, since lots of paper are no longer needed.

This form of communication is becoming the most usual for Governments, and it has been standardized in current administrative electronic notifications services, which are common channels to convey communications and notifications related to official proceedings to registered addressees.

Its importance is growing so much so that in Spain, in future years, this electronic notification system is intended to be the only available for official communications; in fact, from January 2011, Spanish Treasury has established an obligatory electronic notifications service (NEO) for legal entities (Inc. and Ltd. Companies) which at the moment is still voluntary for the rest of the users. NEO service means that obliged entities will only receive electronic notifications instead of printed ones.

In Spain, administrative electronic notifications service is rendered through internet by Authorized Email

Address System (DEH), supported by national entities such as Treasury or Patents and Trademarks Office, and by regional and local entities.

Authorized Email Address (DEH) is an electronic mailbox assigned to any individual or legal entity that requests it, on which compulsory or voluntary electronic administrative notifications are placed. However, in the case of compulsory electronic administrative notifications, Authorized Email Address for obliged users is assigned ex officio.

DEH system (regulated by Order PRE/878/2010, BOE 12 April 2010) is owned by Ministry of Public Administrations and managed by Spanish Post Office through webpage https://notificaciones.060.es.

In order to use this service, applicant must create his Authorized Email Address using a digital ID card (in the case of individuals) or a standard Digital Certificate (for legal entities) and join the service completing an electronic form hosted on above-mentioned webpage. Users are required to provide an email and a post mail address.

An electronic mailbox associated with Authorized Email Address is automatically created. On that mailbox users can check notifications received from administrative proceedings concerning them, or notifications from proceedings concerning third parties for which they have been previously authorized by that other party. Anyway, if Administration has previously informed end user of compulsory electronic notifications that those notifications will be sent through DEH system, as it has been happening in Spain in the case of relationships between Treasury and legal entities, it is not necessary for those entities to join the system by themselves, because their Authorized Email Address is previously created ex officio by the Administration.

In order to check received electronic notifications, user must enter webpage 060.es on his browser and access his electronic mailbox through a navigation tool named “Enter”. Once in mailbox, on tabs “Notifications” and “Communications” user will find all notifications and communications received classified according to sender public entity and, when appropriate, on tab “Authorized” will be able to check notifications and communications sent to other Authorized Email Addresses for which he has been previously authorized by addressees. Before checking notifications, user must decide whether to read and save them on his computer or reject and return them to sender.

Only the holder or an authorized user of an Authorized Email Address will be able to gain access to the electronic mailbox and notifications contained on it. An example of an authorized user is any individual or legal entity (such a handling center) holder of an electronic certificate that has been previously authorized by its clients with a letter of authorization submitted to the Administration that sends those notifications. Once that letter of authorization is received and accepted by that Administration, authorized user is able to gain access to electronic communications and notifications sent to his client, who is also able to gain access to his mailbox on his own.

### BACKGROUND OF THE INVENTION

Above-mentioned communication scenario, created by administrative electronic notifications (NEO) system that in Spain is posed by webpage 060.es and by similar webpages in other countries, is not free of some problems and inconveniences for users, especially when those communications are compulsory electronic notifications (NEO) from Spanish Treasury due to its special features and consequences, particularly when users are authorized intermediaries, which is very common for such Treasury notifications that are usually sent to companies and entities that commonly delegate their tax affairs to agencies, external accountants or handling centers.

It must be taken into account that addressees of NEO service must enter periodically on their mailboxes, at least every ten days, because any notification sent and not opened after that period is considered as notified, with same consequences as if it had been rejected if received by post. After 30 days, users can only check their notifications logging in Treasury webpage as they will no longer be stored into their mailboxes, but period for response will have reached its deadline.

It may seem that for end user of such compulsory electronic notifications following his authorized email address does not mean any problem, especially if it is taken into account that there also exists an informal notice system carried out by electronic means such as email, SMS or others, sent to registered users. For instance, Treasury optionally sends users an email informing them when a new communication or notification is deposited on their mailbox. However, experience shows that these emails are frequently forgotten, and not even opened by addressees, so there exists a high risk of not meeting those important notifications, apart from other risks such as receiving those emails in “spam” folder of mailbox, incorrect email addresses on Treasury database or other technical failures that may prevent users from receiving emails and, therefore, meeting important notifications before deadline.

This is a serious problem for intermediaries, it is to say, agencies, consultancies, external accountants or handling centers, that are responsible of managing notifications received from Treasury or other public agencies and addressed to their clients, because they have to check almost daily, on their “Authorized” tab, electronic mailboxes of people or entities they represent.

These intermediaries demand a service capable to do that work for them, that means, a direct email notice service updating the situation of their client's mailboxes, daily confirming the lack of new notifications or, if new notifications have been posted on inbox, informing about that fact and detailing addressee and proceeding and attaching the notification.

This kind of service is also useful for end users due to the unusual of those notifications that may cause lack of attention, what can be solved with a daily notice service. Moreover, shortcomings and delays resulting from above-discussed technical problems would be avoided.

This additional advisory system for users of electronic compulsory notifications service of Treasury, and electronic notifications in general, is disclosed herein, solving previously mentioned problems.

System in question monitors and controls any electronically sent notification by any present or future administrative electronic notification service similar to existing service managed by Spanish Post Office through webpage https://notificaciones.060.es, and may be limited just for obligatory electronic notifications such as those sent by Treasury, or for those proceedings chosen by the user.

As it has been previously shown, system consists basically on preparing a server, connected via internet to Web page 060.es and to terminals of system's enrolled users, being that server equipped with a user's database manager and a web application that allow server to retrieve periodically, for example once a day, using electronic ID codes and according to different criteria, notifications deposited on mailboxes associated to users' assigned Authorized Email Addresses, process these notifications, generate a report of them and sent that report, together with each notification's associated documents previously downloaded, to user's devices by email or other electronic means.

This management system for administrative electronic notifications is considered to be truly novel. Searches made on Spanish Patent Database “Invenes” did not show any patent about an identical or similar system or process. The only existing patents about management of electronic information are ES2259283-T3, which describes a system for summarizing and sending emails, and ES2294446T3, that discloses a messaging system on which emails are transmitted instantly. Both patents are functionally different from present invention, and also have a different application.

### DETAILED DESCRIPTION OF THE INVENTION

Present administrative electronic notifications management system basically consists on a computer-based server connected via internet with the webpage that hosts mailboxes held by all users of the electronic administrative notifications service, which in Spain is webpage http://notificaciones.060.es managed by Spanish Post Office, and with enrolled users' devices, being these users holders of corresponding authorized email addresses of those mailboxes, either final users or authorized intermediary users.

Said main computer supports an enrolled users database and operates under certain OS software, such as a database manager, a web application and an Internet security software, which allow computer to run a cyclical process through which notifications contained on mailboxes are retrieved according to different search criteria for each user contained on database and, by means of corresponding digital certificate, to process those notifications and generate a report and, finally, to send that report by email along with downloaded notifications or, optionally, print and send them by post, simultaneously or alternatively to the email.

Said system enrolled users electronic address is the authorized email address.

Database is secure and managed by specific software installed on it which acts as interface among database, user and system's web application. Database manager creates and modifies, due to a standard data collection front-end, a register for each enrolled user, named as “#mailbox#”, that contains user's digital certificate or electronic identification code, email address, post address, other user's data as name or tax ID number, optional search profile established by user according to administrative proceedings on which he or his authorized are concerned, profile of information and documents reception, being “only by email” the first option, as well as the subsequently generated report on text or pdf format containing notifications received on user's mailbox according to search profile, and downloaded notifications indexed on that report.

Creating, modifying or updating users' registers on database process is completely independent from mailboxes checking process carried out by system's web application, which represents the essential part of the system.

Web application installed on server has a double function. By one side, allows users to insert their data on system's database from their devices while joining it, being those data their digital certificate or electronic ID code, web and post mail address and other data, as well as chosen information search and reception profiles. Once those data are inserted on server, a register called “#mailbox#” is created. By other side, web application runs a cyclic process based on enrolled users database, through which notifications contained on users authorized email addresses are retrieved and reports are generated and sent to user's devices via email along with those retrieved notifications.

This cyclic process of web application is run on background by means of a periodic connection, through a loop, to database hosted on the server. Connection period can be easily modified to N periods, but it is foreseen for a 24 hour period, it is to say, once per day. When connection to database is established, application extracts each user's data from “#mailbox#” register according to a previously determined order, and establishes another connection via internet with service's webpage, similar to webpage notificaciones.060.es, to gain access to the electronic mailbox associated with assigned authorized email address, called DEH on Spanish webpage, through corresponding digital certificate or personal electronic code, being system also capable of discriminating, retrieving and downloading information and documents contained on “notifications” and “communications” boxes of user's and previously authorized users mailboxes, basing that discrimination on organizations and administrative proceedings previously established on search profile. After that, system generates a report in text, pdf or other format, includes that report on “#mailbox#” register in database along with downloaded notification and communication documents, and electronically sends report and documents to user's device, according to preferences previously stored on main database. Alternatively, report and documents can also be printed and sent to user by post mail.

It is worth mentioning that electronic mean for sending reports and downloaded documents to users is not limited to conventional email, but it can also be any accepted mean such as registered email, SMS or registered SMS.

It must also be highlighted that web application can be programmed for just managing obligatory communications and notifications, which in Spain are those coming from

Treasury as NEO system notifications, because those are the ones that demand a higher control and for which system is more useful to users.

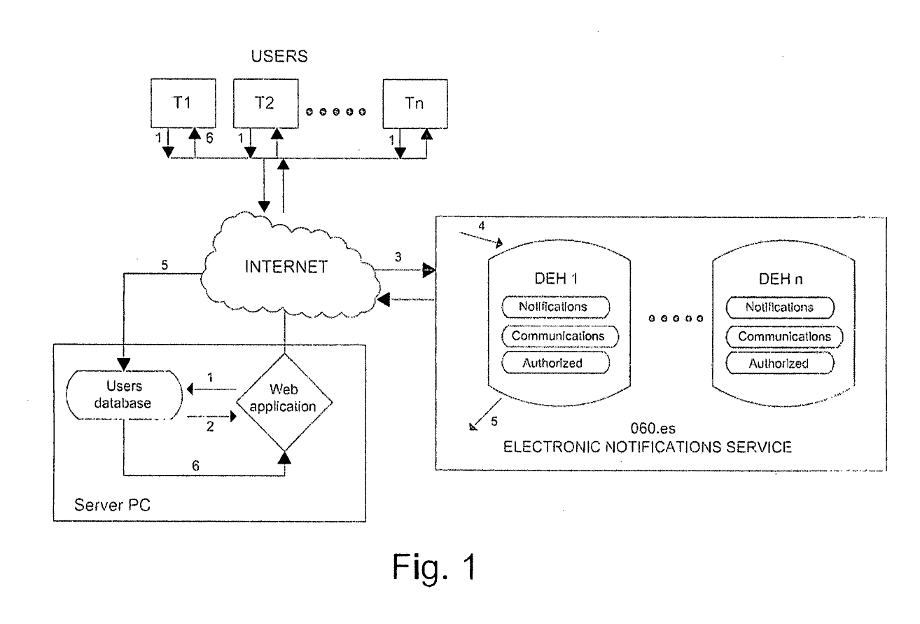

Considering diagram shown on FIG. 1 of present application, which is specified for Spanish Administration service notificaciones.060.es, is easy to understand interconnections and data flows produced among elements constituting system's basic architecture, which are the following:
1) Creation of “#mailbox#” register for each user by means of the inclusion, made by end or authorized users, of their data on server's database, being that data at least their email and post address, and of their notifications search and reception profiles. Users include that information from their devices and through their digital certificate or electronic ID code;
2) Initial connection of system's web application with database and extraction of digital certificate or electronic ID code and first user's search profile, being that first user selected according to a pre-established order;
3) Connection via Internet to service provider entity's webpage, on which user's “#mailbox#” acts as client, using corresponding digital certificate or electronic ID code as identification;
4) Access to mailbox associated with user's authorized email address and retrieval of user's or authorized user's notifications and communications, according to previously-established criteria on search profile;
5) Creation of a report in text, pdf or other format, of notifications and communications classified according to concerned user and proceedings, and storage of report on database together with retrieved documents;
6) Extraction of email address and, if applicable, post address, and sending of report and retrieved documents via email and, if applicable, printing of report and documents with a letter for post remittance;
7) End of connection for first user and re-start of the process with next user's register “#mailbox#”, being process run until all “#mailbox#” registers contained on database are checked.
8) Process run suspension during a pre-established period and re-start after that period with a new connection with database and extraction of digital certificate or electronic ID code of first user.

Each process cycle ends when all “#mailbox#” registers contained on database on that moment are checked.

Thanks to described system, management of obligatory and voluntary notices issued by Administration is easier and faster. Another advantage is that deadlines are not exceeded due to system's regular recurrence, which runs every 24 hours or even, if configured this way, every hour. As it has been previously explained, deadlines for answering or acknowledging receipt of notifications received from Spanish Treasury's NEO system are just of ten days. After every system's cycle a detailed report of new notifications received is created and sent, along with downloaded documents, to user's previously established email address, so deadlines will never expire.

It also must be considered as an important advantage that with this system delays on attending notifications due to technical failures are avoided. Those failures, as it has been previously indicated, can happen due to very usual situations such as filling emails received from Administration on mailbox's SPAM folder, wrong storage of user's email address on Administration's databases or failures on sender's or addressee's email service providers.

Another advantage, which is highly interesting for authorized users who have to manage many proceedings for a high number of clients, as handling centers, is that reports created by this system allow a detailed and personalized monitoring of proceedings, because these reports are detailed for each proceeding and user registered on the database. Reports make monitoring easier and also avoid the need of having to check constantly client's mailboxes because they include attached documents associated with any new notification.

If client wants it, system also generates another report, similar to the electronic, that is printed and sent by post mail to client's address, together with printed notifications and communications issued by Administration. It is also foreseen the possibility of sending notices via text message to user's mobile phone.

1. System for managing administrative electronic notifications for obligatory or voluntary services provided on internet by local, regional, national or intergovernmental Administrations, by means of webpages created for this purpose on which mailboxes are hosted, being those mailboxes associated with electronic addresses previously assigned to final or authorized users, being this system characterized by a basic architecture consisting of a computer database server connected via internet to service provider Administrative entity's webpage and to final or authorized users' devices, which manages an enrolled users database and runs under some determined OS software, database manager, web application and internet security that allow system, according to previously fixed searching criteria, retrieving notifications deposited on mailboxes associated to users' assigned Authorized Email Addresses by means of corresponding digital certificate or any other electronic ID, processing these notifications, generating a report of them and sending that report, along with each notification's associated documents previously downloaded, to user's devices by email or, alternatively, by post mail to user's mailboxes.

2. System for managing administrative electronic notifications, according to first claim, wherein server's database manager has the functionality of creating and modifying, through a data collection standard frontend, a register for each enrolled user, designated as “#mailbox#” entity, which contains user's digital certificate or electronic ID code, email address, post address and other user's data, information retrieving profiles previously established by user according to administrative proceedings concerning user or his clients, which by default is command “all”, information and documents reception profiles, which by default is command “only by email”, created report containing notifications received on user's Authorized Email Address according to information retrieving profile, and notifications indexed on the report.

3. System for managing administrative electronic notifications, according to first and second claims, wherein server's web application has the functionality of including user's digital certificate or electronic ID code, user's email and post addresses as well as other identification data and information and documents search and reception profiles provided by users through their devices, on each user's “#mailbox#” register on database.

4. System for managing administrative electronic notifications, according to first and second claims, wherein server's web application has the functionality of running a process on background through which web application regularly connects, through a loop, to database hosted on the server, each N period, extracts each user's data from “#mailbox#” register according to a previously determined order, establishes another connection via internet to service's webpage, gains access to the electronic mailbox associated with assigned authorized email address through corresponding digital certificate or personal electronic code, discriminates, retrieves and downloads information and documents contained on “notifications” and “communications” boxes of user's and previously authorized users mailboxes, basing that discrimination on organizations and administrative proceedings previously established on user's search profile, generates a report of retrieved notifications and communications in text, pdf or other format, includes that report on “#mailbox#” register in database together with downloaded notification and communication documents and electronically sends report and documents to user's device or, alternatively, prints report and documents to be sent to user by post mail.

5. System for managing administrative electronic notifications, according to fourth claim, wherein background running process' periodicity is every 24 hours, daily.

6. System for managing administrative electronic notifications, according to fourth and fifth claims, wherein server's web application has the functionality of discriminating and retrieving by default only obligatory notifications and communications, which in Spain are at least those coming from Treasury.

7. System for managing administrative electronic notifications, according to fourth, fifth and sixth claims, wherein electronic mean for sending report and downloaded documents to interested user is email, certified email, SMS or certified SMS.

8. System for managing administrative electronic notifications, according to previous claims, wherein following interconnections and data flows among elements constituting system's basic architecture are produced: (1) Creation of “#mailbox#” register for each user by means of the inclusion at any time, made by end or authorized users through their devices, of their data on server's database, being that data their digital certificate or electronic ID code, their email and post address, and of their notifications search and reception profiles;(2) Initial connection to database and extraction of digital certificate or electronic ID code and first user's search profile, being that first user selected according to a pre-established order; (3) Internet connection to service provider entity's webpage, on which user's “#mailbox#” acts as client, using corresponding digital certificate or electronic ID code as identification; (4) Access to mailbox associated with user's authorized email address and retrieval of user's or authorized user's notifications and communications, according to previously established criteria on search profile; (5) Creation of a report in text, pdf or other format, of notifications and communications classified according to concerned user and proceedings, and storage of report on database together with retrieved documents; (6) Extraction of email address and, if applicable, post address, and sending of report and retrieved documents via email and, if applicable, printing of report and documents with a letter for post mail remittance; (7) End of connection for first user and re-start of the process with next user's register “#mailbox#”, being process run until all “#mailbox#” registers contained on database are checked; (8) Process' run suspension during a pre-established period and re-start after that period with a new connection to database and extraction of digital certificate or electronic ID code of first user.

9. System for managing administrative electronic notifications, according to all previous claims, wherein administrative electronic notifications come from same-named service rendered via internet through webpage https://notificaciones.060.es managed by Spanish Post Office, by means of Authorized Email Address system (NEO), supported by Spanish public entities.
